(19) United States
(12) Patent Application Publication
(10) Pub. No.: US 2026/0256229 A1
(43) Pub. Date: Sep. 3, 2026

(54) SYSTEM AND METHOD FOR A WEARABLE FOOD AND MEDICINE STORAGE SYSTEM INTEGRATED WITH APPAREL

(71) Applicant: Mohamed Mostafa Snosy, Tallahassee, FL (US)

(72) Inventor: Mohamed Mostafa Snosy, Tallahassee, FL (US)

(21) Appl. No.: 19/390,491

(22) Filed: Nov. 15, 2025

Related U.S. Application Data
(60) Provisional application No. 63/765,778, filed on Mar. 3, 2025.

(51) Int. Cl. A41D 27/20; A61J 1/16

(52) U.S. Cl. CPC A41D 27/208; A61J 1/165

(57) ABSTRACT

A garment featuring an integrated pocket system designed for hygienic storage of food items or medications, separate from personal belongings. The food-safe pocket includes a removable, washable liner made of antimicrobial, BPA-free materials, with optional insulation, cooling inserts, and wireless temperature monitoring for maintaining freshness. Additional pockets, such as those in pants, jackets, hoodies, or cultural clothing like abayas, provide dedicated storage for personal items like phones, wallets, or keys. A moisture barrier ensures sanitary separation between compartments. The system is adaptable across various garment types and placements, including front, side, or thigh pockets, offering multifunctional, temperature-controlled wearable storage for diverse lifestyles.

### CROSS REFERENCE TO RELATED APPLICATIONS

This claims priority to United States Provisional Patent Application 63/765,778 filed on Mar. 3, 2025 and is incorporated in its entirety

### FIELD OF THE INVENTION

The present invention relates to garments and wearable storage systems, and more particularly to garments having an integrated dual-layer pocket system configured for hygienic food storage, medicine storage, and simultaneous organization of personal belongings.

### BACKGROUND

Traditional garments such as hoodies, jackets, t-shirts, pants, abayas, jalabiya, jilbab and sweatshirts commonly feature front pockets, typically in the form of a single kangaroo pocket or side pockets. These pockets are designed primarily for warming hands or storing personal items such as phones, keys, or wallets. However, modern lifestyles increasingly demand multifunctional clothing that can accommodate various needs simultaneously. A common problem faced by many is the need to carry both snacks and personal items while maintaining mobility and hygiene.

Current garment designs force users to either mix food items with potentially contaminated personal belongings in the same pocket space, use separate bags or containers, or forgo convenient snack storage altogether. Furthermore, traditional pockets lack hygienic food storage capabilities. Placing unwrapped or partially wrapped snacks directly into fabric pockets exposes food to lint, dust, germs, and residue from previously stored items. This is particularly problematic in office environments where users seek alternatives to potentially contaminated break room surfaces. Accordingly, there is a need for a garment with wearable food and medicine storage system that maintains hygienic separation between food and gear, Provides temperature control for snacks or medications, Offers easy cleaning through removable liners, and Is integrated seamlessly into daily apparel without sacrificing comfort or aesthetics.

### SUMMARY

The present disclosure relates to a wearable food and medicine storage system integrated into everyday apparel. Modern users, including athletes, cyclists, outdoor workers, medical patients, and busy parents, often require convenient access to nourishment and temperature-sensitive medical supplies without carrying additional bags or containers. Existing garments provide limited storage options that are unsuitable for maintaining hygiene, organization, and temperature control.

In one aspect, the garment incorporates a dual-layer pocket system positioned on the body of the clothing. The outer pocket is designed as a food-and medicine-safe compartment with a removable, washable liner made from antimicrobial, non-toxic, FDA-compliant, and OEKO-TEX-certified, antimicrobial, BPA-free materials. This outer pocket may further include insulated linings, removable cooling inserts, or thermal packs to maintain safe storage conditions for snacks or medical supplies. In some embodiments, the outer pocket includes a Bluetooth-enabled temperature sensor configured to transmit data to a mobile application, allowing real-time monitoring of pocket temperature.

The inner pocket, positioned behind the outer pocket, is designed for personal belongings such as phones, keys, or wallets, and may include fleece lining or optional dividers. A moisture barrier separates the outer and inner pockets, ensuring hygienic isolation between food/medical items and personal gear.

The garment may further include expandable pockets, transparent or mesh windows for visibility, reflective trims for nighttime use, and ergonomic placement to balance comfort and accessibility. The system is adaptable to various apparel types, including jackets, hoodies, t-shirts, pants, cargo pants, abayas, kaftans, and jilbabs, thereby extending usability across cultural and lifestyle needs.

This invention provides a sanitary, temperature-controlled, and multifunctional storage solution seamlessly integrated into daily clothing, redefining wearable convenience for individuals requiring food, hydration, or medical storage while on the move.

The present invention relates to a wearable food and medicine storage system integrated into daily apparel. The system incorporates a dual-layer pocket configuration that provides hygienic and temperature-controlled storage for food items and temperature-sensitive medical supplies, while maintaining convenient access and isolation from personal belongings. Unlike traditional garments, which provide only basic storage functions, the present invention integrates insulation, washable liners, moisture barriers, and optional smart connectivity into various garment types, enabling multifunctional use for modern lifestyles.

The garment may include a body portion selected from a variety of apparel forms, such as jackets, hoodies, sweatshirts, pullovers, t-shirts, pants, cargo pants, vests, abayas, kaftans, and jilbabs. Each garment may incorporate at least one dual-layer pocket system positioned at the front, side, thigh, or interior lining of the body portion, depending on garment type and ergonomic considerations.

The dual-layer pocket system includes an Outer Pocket (“Storage Layer”) configured for food items or medications and an Inner Pocket (“Gear Layer”) that is positioned behind the outer pocket for personal belongings.

There may be a moisture barrier separating the two layers to prevent contamination. The outer pocket is designed with a removable liner constructed from FDA-approved, OEKO-TEXcertified, food-safe fabric that is antimicrobial, w ashable, and quick-drying. In some embodiments, the liner includes. The system may include removable gel packs, cooling inserts, or thermal packs to extend freshness of food and medications. The system may include closures for the outer pocket may include horizontal zippers, flaps, hook-and-loop fasteners, or magnetic closures.

In some embodiments, the outer pocket integrates temperature regulation features to resist heat transfer from the wearer's body or external environment

The system may include Bluetooth-enabled temperature sensors configured to transmit pocket temperature to a paired mobile application. This allows wearers to monitor and track storage conditions in real time, which is particularly advantageous for medications such as insulin.

The inner pocket may be positioned directly behind the outer pocket and may extend substantially across the width of the garment to form a kangaroo-style configuration. Access is provided through vertically oriented zippers located on one or both sides, allowing ambidextrous entry.

The inner pocket may include soft fleece lining for comfort and protection of electronic devices, optional dividers or sub-pockets for organization of phones, wallets, tools, or keys, and expandable compartments for increased storage. The pockets may be strategically positioned to ensure comfort, weight distribution, and balance for the wearer. For example: chest or side pockets for cyclists and climbers, thigh pockets for cargo pants or workwear, hidden insulated pockets integrated into abayas, kaftans, and jilbabs to preserve modesty while ensuring accessibility.

A system and method for a garment with pocket having a panel with a removable, food-safe liner. The liner may be BPA-free, antimicrobial, and machine-washable. The garment may include an upgraded kangaroo pocket upgraded with soft fleece lining and optional internal dividers for a user's phone, tools, or technology. The garment may have matte finish, that is perfect for delivery drivers, students, parents, photographers, dog walkers, and office professionals who want a sanitary snack spot.

### BRIEF DESCRIPTION OF THE SEVERAL VIEWS OF THE DRAWINGS

FIG. 1 shows a perspective view of a use wearing the garment with the dual-layer pocket system according to exemplary embodiments hereof.

FIG. 2 shows a front view of the dual-layer pocket system according to exemplary embodiments hereof.

FIG. 3 shows views of the garment with the pockets open revealing the food-safe liner according to exemplary embodiments hereof; and

FIG. 4 shows a perspective view of a use wearing the garment with the dual-layer pocket system.

FIG. 5 shows a perspective view of a pants embodiment.

FIG. 6 shows a perspective view of a shorts embodiment.

FIG. 7 shows a perspective view of a cargo shots embodiment.

### DETAILED DESCRIPTION OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

The present invention is directed to a garment such as an upper torso apparel (e.g., hoodies, jackets, sweatshirts, pullovers, coats, etc.) that is combined with an innovative dual-layer pocket system. The dual-layer pocket system provides separate, dedicated storage spaces for food items and personal belongings while maintaining the aesthetic and functional qualities of traditional garment pockets.

For the purposes of this specification, the garment will be described as a jacket with an integrated dual-layer front pocket system. However, it is understood by a person of ordinary skill in the art that the dual-layer pocket system may be incorporated into any type of garment including, without limitation, jackets, coats, pants, shorts, vests, dresses, skirts, sweatshirts, pullovers, abayas, kaftans, and jilbabs, thereby extending usability across cultural and lifestyle needs.

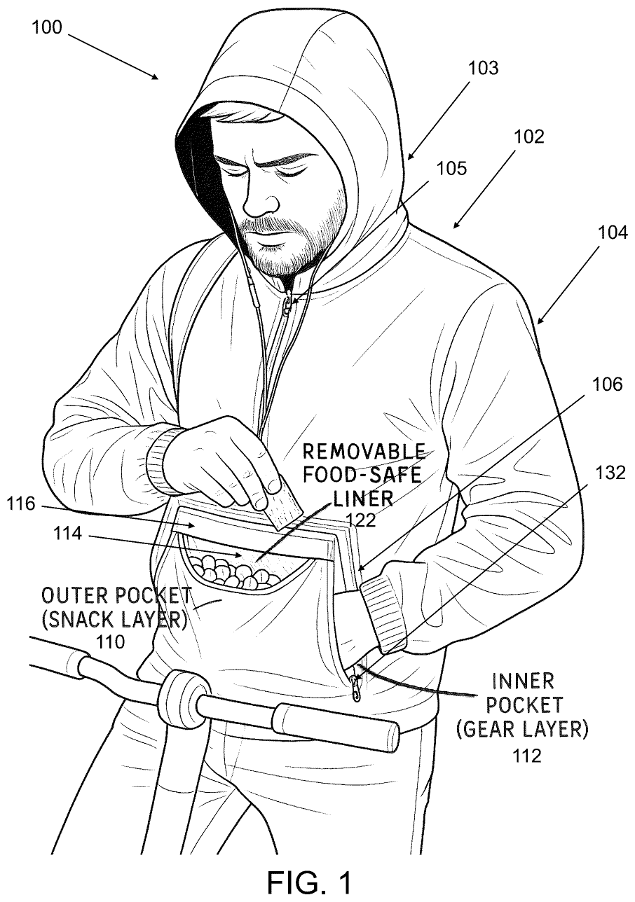

According to exemplary embodiments hereof, FIG. 1 illustrates one embodiment of garment 100. Garment 100 viewed from the front and including a body portion 102, a hood 103, a zipper 105, left and right sleeves 104 and a dual-layer pocket system 106 positioned on the front of the body portion 102. However this is non-limiting and may be positioned on any part of the garment such as the side and back.

The dual-layer pocket system 106 includes an outer pocket 110 (also referred to as the “snack layer”) and an inner pocket 112 (also referred to as the “gear layer”) positioned behind the outer pocket 110. The two layers are constructed to function independently while maintaining a streamlined appearance for the wearer that is subtly introduced and streamlined.

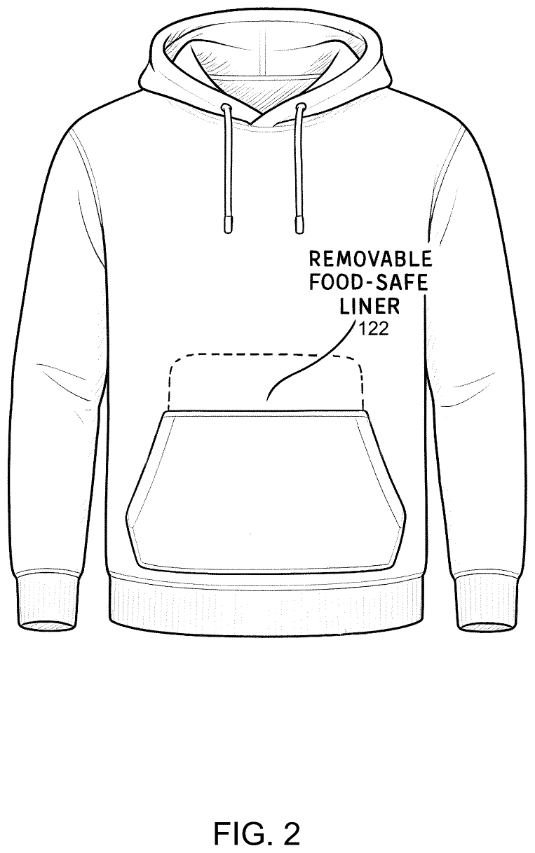

The outer pocket 110 includes a first opening that is coverable by a first closure mechanism 116. In one or more non-limiting embodiments, the first closure mechanism 116 includes a flap which extends over the first opening 114 in a first closed position and upward away from the first opening 114 such that the user may gain access to the contents of the first pocket 110, as illustrated in FIG. 2.

In further embodiments, the first closure mechanism 116 may include instead of or in addition to the flap, a zipper oriented horizontally, extending from a first side to a second side of the outer pocket 110. This horizontal orientation allows for easy access snacks or other food items while maintaining a secure closure.

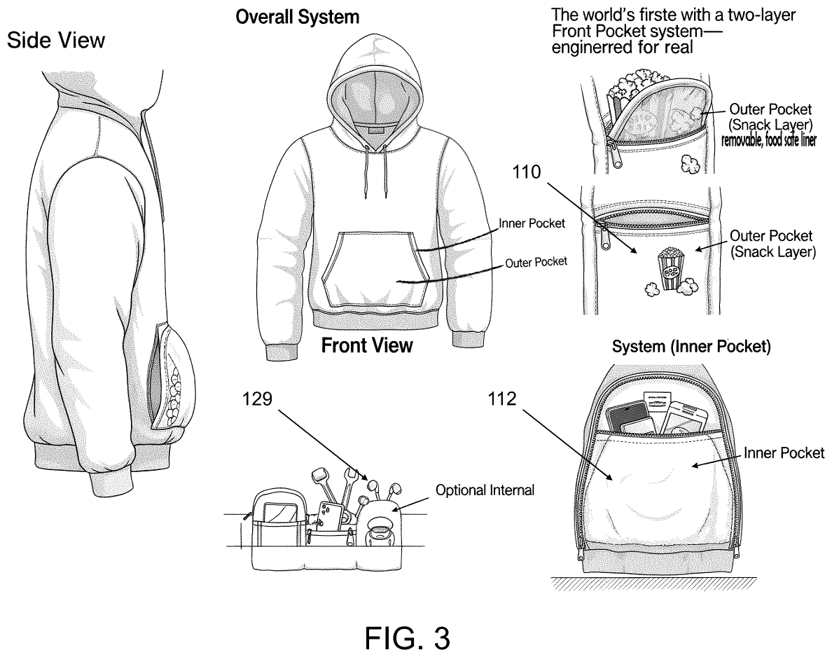

As shown in FIG. 3, the outer pocket 110 includes a removable food-safe liner 122 The liner 122 is specifically designed for hygienic food storage and is constructed from BPA-free materials with antimicrobial properties. The liner 122 may machine-washable, allowing users to maintain cleanliness between uses after removing the liner from outer pocket 110.

In some embodiments, the removable food-safe liner 122 includes a semi-rigid bottom portion that helps maintain the shape of the liner 122 when holding food items such as popcorn, trail mix, fruit, or other snacks. The liner 122 may also include ventilation perforations to prevent moisture accumulation that could lead to food spoilage or bacterial growth. The removable food-safe liner 122 is secured within the outer pocket 110 through any number of attachments such as snaps, hook and loop fasteners, magnetic closures, or clips positioned at strategic points within the outer pocket 110.

The inner pocket 112, as shown in FIG. 3, includes at least one second opening 130 with at least one second closure mechanism 132. In preferred embodiments, the second closure mechanism 132 includes one or more zippers oriented substantially vertically along the side edges 134 of the inner pocket 112.

In some embodiments, the inner pocket 112 includes two vertical zippers positioned at the left and right sides respectively, allowing ambidextrous access to the pocket interior. However this is non-limiting and garment 100 may only include one zipper on either side. The vertical orientation of these zippers distinguishes them from the horizontal zipper of the outer pocket 110 and allows users to insert their hands in a traditional manner similar to a kangaroo pocket to store their items.

The inner pocket 112 spans substantially across a width of the front of the body portion 102, creating a kangaroo-style pocket configuration. The interior of the inner pocket 112 may include a soft fleece lining for safe passage for the contents.

In some embodiments, the inner pocket 112 includes optional internal dividers or sub-pockets 129 as illustrated in FIG. 3. These dividers may be removable, adjustable, extendable, or fixed, and serve to organize personal items such as phones, keys, wallets, tools, or other belongings. The dividers may be constructed from flexible fabric, semi-rigid plastic, or other suitable materials.

A moisture barrier may be positioned between the outer pocket 110 and the inner pocket 112. This barrier prevents any liquid or moisture from the outer pocket 110 from reaching the inner pocket 112, maintaining separation between food storage and personal item storage areas.

The body portion 102 and the dual-layer pocket system 106 may be constructed from water-resistant materials with a matte finish. This construction provides durability and weather protection while maintaining a sleek, professional appearance suitable for various environments including offices, outdoor settings, and casual wear situations.

The dual-layer pocket system 106 may be integrated into the garment 100 during initial manufacture or may be designed as a retrofittable system that can be attached to existing garments. In retrofittable embodiments, the system 106 may include additional attachment mechanisms for securing to the exterior of conventional hoodies, jackets, or other garments.

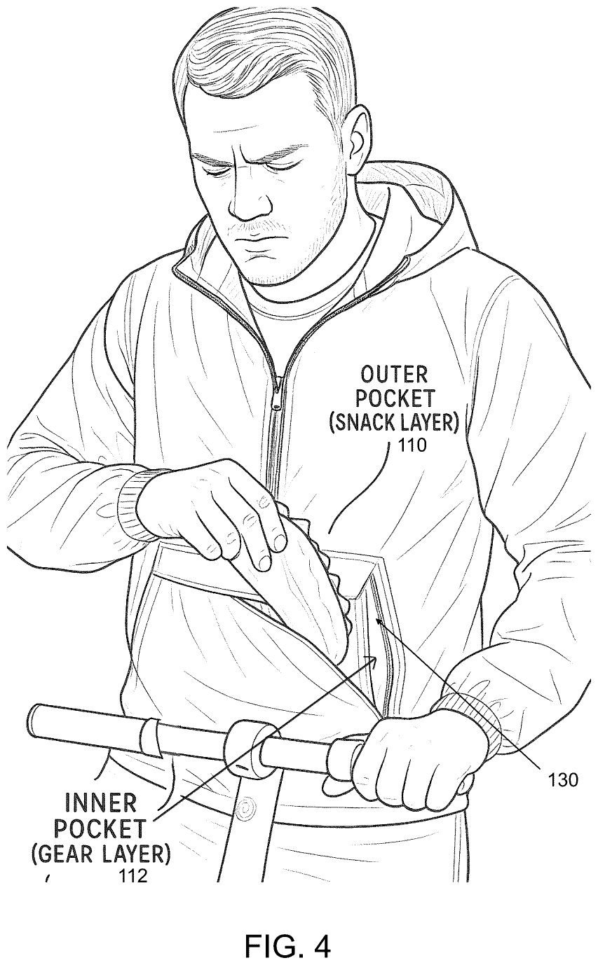

In use, as illustrated in FIG. 4, a wearer can access the outer pocket 110 by operating the first closure mechanism 116 to reveal the food-safe liner 122. Snacks or other food items can be placed directly into the liner 122, which provides a clean, hygienic storage environment. The liner 122 may be removed after use for washing, ensuring continued cleanliness.

Simultaneously, the wearer can access the inner pocket 112 through the second closure mechanism 132 to store personal items or warm their hands. The separation between the two layers ensures that food items remain isolated from potentially contaminated personal belongings.

The dual-layer pocket system 106 is particularly advantageous for professionals who require hands-free snack storage, including delivery drivers who need to eat while maintaining mobility, students who need convenient access to snacks during classes, office workers seeking hygienic alternatives to break room surfaces, parents managing snacks for children, photographers and other field professionals who work extended hours, and dog walkers who need to carry both treats and personal items.

In some embodiments, the first outer pocket layer 110 includes one or more cooling element sleeves positioned along interior walls of the pocket. These sleeves are configured to receive and retain flexible refrigerator gel packs, ice packs, or phase-change material cooling elements. The cooling element sleeves may be constructed from insulated fabric material and positioned strategically to surround the food storage area while maintaining separation from the food-safe line

Each sleeve may include an opening with a closure mechanism such as hook and loop fasteners or elastic binding to secure the cooling elements in place. The sleeves are preferably positioned at the lateral sides and bottom portion of the first outer pocket layer to create a temperature-controlled environment. The incorporation of cooling element sleeves enables the garment to maintain food items at safe temperatures for extended periods, particularly beneficial for perishable snacks, medications, or beverages during outdoor activities or extended work shifts.

In another embodiment, the garment 100 includes an integrated temperature monitoring system including one or more wireless enabled temperature sensors 156 positioned within the first outer pocket layer 110 or inner pocket layer 112. The temperature sensors 156 may be embedded in the pocket lining or removably attached via clips or magnetic mounts, allowing for monitoring of the internal pocket temperature. The sensors 156 communicate wirelessly with a user's mobile device 400 through a dedicated application or network, providing real-time temperature data, historical temperature logs, and customizable alerts when temperatures exceed predetermined thresholds. The temperature monitoring system may include a rechargeable battery unit integrated into the garment seam or positioned in a dedicated pocket.

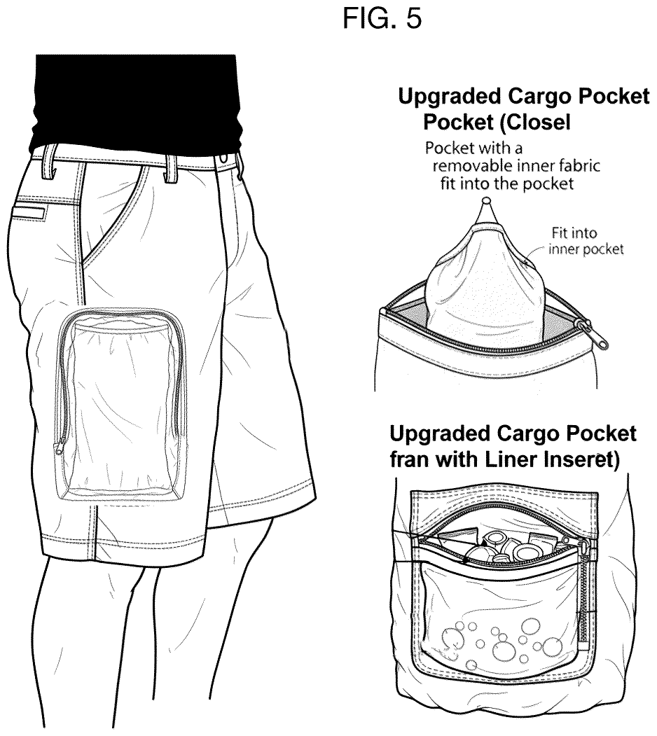

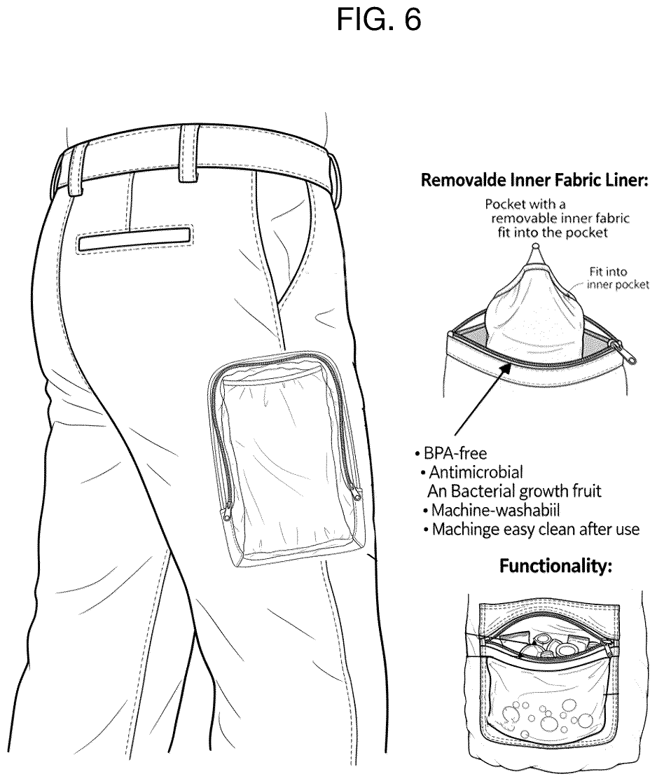

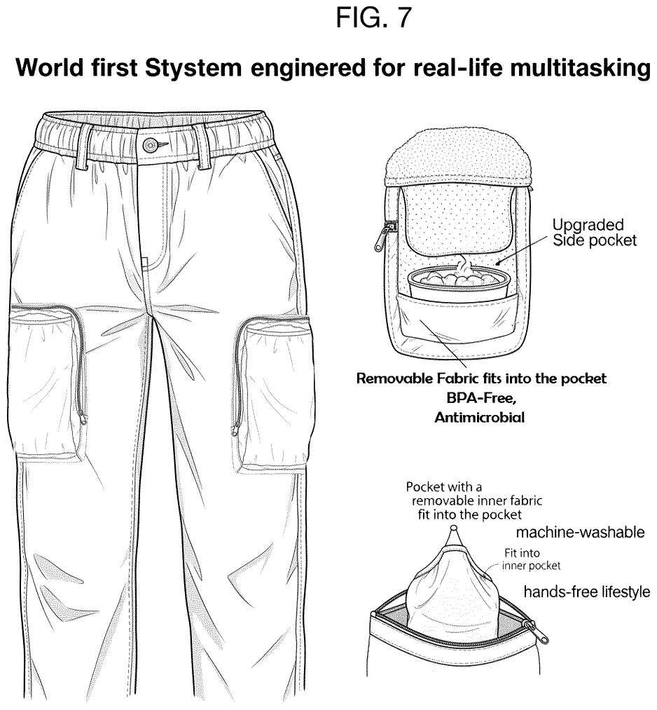

The innovative dual-layer pocket system 106 represents an advancement in functional garment design, addressing the modern need for hygienic, convenient food storage while maintaining traditional pocket functionality for personal items that may be used in various articles of clothing including but not limited to those in FIGS. 5, 6, and 7.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. A garment comprising: a body portion;
a dual-layer pocket system positioned on the body portion, wherein the dual-layer pocket system has an outer pocket and an inner pocket positioned behind the outer pocket.

2. The garment of claim 1, further comprising a removable food-safe liner positioned within the outer pocket.

3. The garment of claim 2 wherein the removable food-safe liner is BPA-free, antimicrobial, and machine-washable.

4. The garment of claim 1, wherein the outer pocket has a first closure mechanism oriented substantially horizontally.

5. The garment of claim 4 wherein the first closure mechanism comprises a flap.

6. The garment of claim 4, wherein the inner pocket has at least one second opening with at least one second closure mechanism oriented substantially vertically.

7. The garment of claim 6 wherein the at least one second closure mechanism comprises at least one zipper extending vertically along at least one side edge of the inner pocket.

8. The garment of claim 1 wherein the inner pocket includes a soft fleece lining.

9. The garment of claim 1 further comprising a moisture barrier positioned between the outer pocket and the inner pocket.

10. The garment of claim 1 wherein the garment body comprises a water-resistant material with a matte finish.

11. The garment of claim 1 wherein the inner pocket spans substantially across a width of the front portion of the body portion to form a kangaroo-style pocket.

12. The garment of claim 1 further comprising one or more sensors to detect temperature in the dual-layer pocket system.

13. The garment of claim 1 further comprising one or more refrigerant packs positioned in the dual-layer pocket system.

14. A dual-layer pocket system for a garment comprising: a first pocket for food items, the first pocket having a closure mechanism; a removable, food-safe liner configured to be positioned within the first pocket; a second pocket for gear items, the second pocket positioned behind the first pocket; and at least one vertically-oriented opening with a closure mechanism providing access to the second pocket.
